(19) United States
(12) Patent Application Publication
(10) Pub. No.: US 2019/0237999 A1
(43) Pub. Date: Aug. 1, 2019

(54) Wireless Power Transfer for Recharging Aircraft Batteries

(71) Applicant: The Boeing Company, Chicago, IL (US)

(72) Inventors: Brian J. Tillotson, Kent, WA (US); Teiyuri Aoshima, Bothell, WA (US)

(73) Assignee: The Boeing Company, Chicago, IL (US)

(21) Appl. No.: 15/886,362

(22) Filed: Feb. 1, 2018

(51) Int. Cl. H02J 50/12; H02J 50/90; B64C 3/32; H02J 7/02; H01F 38/14

(52) U.S. Cl. CPC H02J 50/12; H02J 50/90; B64C 2201/066; H02J 7/025; H01F 38/14; B64C 3/32

(57) ABSTRACT

Systems and methods for recharging the battery onboard an aircraft (hereinafter “receiving aircraft”) via resonant inductive coupling. In accordance with some embodiments, wireless power transfer to the receiving aircraft is effected by means of a second aircraft (hereinafter “transmitting aircraft”). The receiving and transmitting aircraft are both equipped with respective LC circuits. The aircraft fly in a formation such that transmit coils onboard the transmitting aircraft and receive coils onboard the receiving aircraft are separated by a distance within a resonant inductive coupling range. During the recharge procedure, each transmit coil is driven by an alternating current source having a frequency equal to the resonant frequency of the LC circuit onboard the receiving aircraft. The receive coils then feed the induced alternating current to a rectifier for supplying direct current to the onboard battery charger.

### BACKGROUND

This disclosure generally relates to systems and methods for wireless power transfer. In particular, this disclosure relates to wireless power transfer by resonant inductive coupling.

Fuel-burning aircraft (including piloted airplanes and unmanned aerial vehicles) produce carbon dioxide and noise. To avoid carbon dioxide emissions and reduce noise, it is known to employ electrically propelled aircraft. However, the range and flight duration of electric aircraft are heavily limited by the energy density of batteries.

Aerial recharging overcomes this limitation but creates new challenges. Connecting a recharging cable between two aircraft in flight takes precise maneuvers which require special training for airplane pilots or extra sensors and computers for unmanned aerial vehicles.

Accordingly, it would be desirable to provide a system and a method for recharging a battery onboard an aircraft in flight that does not require a recharging cable.

### SUMMARY

The subject matter disclosed in some detail below is directed to systems and methods for recharging the battery (or batteries) onboard an aircraft (hereinafter “receiving aircraft”) via resonant inductive coupling. The receiving aircraft carries one or more LC circuits that feed the aircraft's battery during recharging. Each LC circuit (also referred to as a “resonant circuit”) is composed of an inductor (hereinafter “coil”) and a capacitor. An LC circuit can act as an electrical resonator, storing energy oscillating at the circuit's resonant frequency. A coil of the LC circuit onboard a receiving aircraft will be referred to herein as a “receive coil”. The receiving aircraft may be a piloted airplane or an unmanned aerial vehicle. The propulsion system of the receiving aircraft may include electric motors or fuel-consuming engines.

In accordance with some embodiments, wireless power transfer to the receiving aircraft is effected by means of a second aircraft (hereinafter “transmitting aircraft”), which also carries one or more LC circuits. A coil of the LC circuit onboard the transmitting aircraft will be referred to herein as a “transmit coil”. The transmitting aircraft may be a piloted airplane or an unmanned aerial vehicle. The propulsion system of the transmitting aircraft may include electric motors or fuel-consuming engines.

In accordance with some embodiments, the receiving and transmitting aircraft fly in a formation such that the transmit coils onboard the transmitting aircraft and the receive coils onboard the receiving aircraft are separated by a distance within a resonant inductive coupling range. During the battery recharge procedure, each transmit coil is driven by an alternating current source having a frequency equal to the resonant frequency of the LC circuit onboard the receiving aircraft. Thus the transmit coils onboard the transmitting aircraft transfer power wirelessly to the receive coils onboard the receiving aircraft. The receive coils then feed the induced alternating current to a rectifier for supplying direct current to the onboard battery charger.

For the greatest amount of current to be induced in the receive coil by the transmit coil, the two aircraft are preferably oriented such that the receive coil is perpendicular to the magnetic flux generated by the transmit coil, that is, the axis of the receive coil is parallel to the magnetic flux. In cases where the receiving aircraft is an electrically propelled (not fuel-consuming) aircraft, the systems and methods proposed herein increase the range and flight duration of the electrically propelled aircraft and reduce the battery size needed, making room for additional payload.

In accordance with other embodiments, wireless power transfer to the receiving aircraft is effected by means of a ground-based transmit coil. For example, the receiving aircraft may fly around a tower equipped with an LC circuit that includes a transmit coil that rotates as the receiving aircraft circumnavigates the tower. Or the receiving aircraft may be parked on the ground, in which case a transmit coil mounted to a ground vehicle may be used to transfer power wirelessly to the receive coil onboard the receiving aircraft.

Although various embodiments of systems and methods for recharging a battery onboard an aircraft via resonant inductive coupling are described in some detail later herein, one or more of those embodiments may be characterized by one or more of the following aspects.

One aspect of the subject matter disclosed in detail below is a method for recharging a battery onboard a receiving aircraft, comprising: positioning the receiving aircraft so that a receive coil onboard the receiving aircraft is within a resonant inductive coupling range of a transmit coil not onboard the receiving aircraft; transferring power wirelessly from the transmit coil to the receive coil onboard the receiving aircraft by supplying an alternating current to the transmit coil while the receive coil is within the resonant inductive coupling range; converting electric current induced in the receive coil to direct current; and charging the battery using at least some of the direct current.

In accordance with some embodiments of the method described in the preceding paragraph, the receiving aircraft and the transmit coil are on the ground during wireless power transfer. In accordance with another embodiment, the transmit coil is mounted to a tower that extends from ground into an airspace and the receiving aircraft is in flight during wireless power transfer. In accordance with other embodiments, the transmit coil is onboard a transmitting aircraft and wireless power transfer occurs while the receiving and transmitting aircraft are concurrently flying within a resonant inductive coupling range of each other. In accordance with yet another embodiment, wireless power transfer occurs after the receiving aircraft has landed on the transmitting aircraft.

Another aspect of the subject matter disclosed in detail below is a battery recharging system comprising a receiving aircraft comprising first and second wings, a tail, a receive coil, a capacitor coupled to the receive coil for tuning the receive coil to a resonant frequency, a rectifier coupled to the receive coil and to the capacitor for converting alternating current from the receive coil and capacitor into direct current; a battery charger coupled to receive direct current from the rectifier, and a battery, wherein the battery charger is configured to charge the battery using direct current produced from alternating current induced in the receive coil and alternating current produced by the capacitor.

In accordance with one embodiment in which the receive coil is incorporated in a wing of the receiving aircraft, the battery recharging system further comprises a transmitting aircraft comprising first and second wings, a transmit coil incorporated in one of the first and second wings, a capacitor coupled to the transmit coil for tuning the transmit coil to the resonant frequency, and an alternating current source connected to the transmit coil and the capacitor, wherein the receive coil and the transmit coil are separated by a distance within a resonant inductive coupling range.

In accordance with one embodiment in which the receive coil is incorporated in the tail of the receiving aircraft, the battery recharging system further comprises a transmitting aircraft comprising a nose, a pole extending forward from the nose, a transmit coil supported at a distal end of the pole, a capacitor coupled to the transmit coil for tuning the transmit coil to the resonant frequency, and an alternating current source connected to the transmit coil, wherein the receive coil and the transmit coil are separated by a distance within a resonant inductive coupling range.

In accordance with other embodiments, the battery recharging system further comprises a tower extending from ground into an airspace, a platform rotatably coupled to the tower, a transmit coil mounted to the platform, a capacitor coupled to the transmit coil for tuning the transmit coil to the resonant frequency, and an alternating current source connected to the transmit coil and the capacitor, wherein the receive coil and the transmit coil are separated by a distance within a resonant inductive coupling range.

A further aspect of the subject matter disclosed in detail below is a battery recharging system comprising: a receiving aircraft comprising wings, a receive coil incorporated in a wing, a capacitor coupled to the receive coil for tuning the receive coil to a resonant frequency, a rectifier coupled to the receive coil and to the capacitor for converting alternating current from the receive coil and capacitor into direct current; a battery charger coupled to receive direct current from the rectifier, and a battery, wherein the battery charger is configured to charge the battery using direct current produced from alternating current induced in the receive coil and alternating current produced by the capacitor; and a transmitting aircraft comprising wings, a transmit coil incorporated in a wing, a capacitor coupled to the transmit coil for tuning the transmit coil to the resonant frequency, and an alternating current source connected to the transmit coil and the capacitor, wherein the receive coil and the transmit coil are separated by a distance within a resonant inductive coupling range. In accordance with some embodiments, the receiving aircraft further comprises a plurality of wheels which are in contact with the transmitting aircraft.

Yet another aspect is an aircraft comprising a nose, a pole extending forward from the nose, a transmit coil supported at a distal end of the pole, a capacitor connected to the transmit coil for tuning the transmit coil to a resonant frequency, and an alternating current source connected to the transmit coil and the capacitor.

Other aspects of systems and methods for recharging a battery onboard an aircraft via resonant inductive coupling are disclosed below.

### BRIEF DESCRIPTION OF THE DRAWINGS

The features, functions and advantages discussed in the preceding section can be achieved independently in various embodiments or may be combined in yet other embodiments. Various embodiments will be hereinafter described with reference to drawings for the purpose of illustrating the above-described and other aspects. None of the diagrams briefly described in this section are drawn to scale.

FIG. 1 is a circuit diagram representing a transmitter and a receiver in a resonant system.

FIG. 2 is a circuit diagram representing a transmitter and a receiver in a non-resonant system.

FIG. 3A is a graph showing current over time in a non-resonant system.

FIG. 3B is a graph showing current over time in a resonant system.

FIG. 4 is a circuit diagram representing a transmitter and a receiver in a resonant system with relay coils.

FIG. 5 is a diagram representing a view of transmitting aircraft and a receiving aircraft flying in formation during wireless power transfer in accordance with one embodiment.

FIG. 6 is a diagram representing a unit sphere model of a magnetic dipole.

FIG. 7 is a diagram representing a transmit coil and various receive coil orientations for maximum flux capture during resonant inductive coupling.

FIG. 8 is a circuit diagram identifying some components of a battery charging system onboard a receiving aircraft in accordance with one embodiment.

FIG. 9 is a diagram representing a front view of a transmitting aircraft and a multiplicity of receiving aircraft flying in formation during wireless power transfer in accordance with another embodiment.

FIG. 10 is a diagram representing a side view of a transmitting aircraft, a leading receiving aircraft and a trailing receiving aircraft flying in formation during wireless power transfer in accordance with a further embodiment.

FIG. 11 is a diagram representing a view of a scenario in which a receiving aircraft receives power via resonant inductive coupling after landing on a transmitting aircraft that continues to fly.

FIG. 12 is a diagram representing a view of a leading receiving aircraft and a trailing transmitting aircraft flying in formation during wireless power transfer in accordance with an alternative embodiment in which the transmit coil is located forward of the nose of the transmitting aircraft and the receive coil is located in the tail of the receiving aircraft.

FIG. 13 is a diagram representing a view of a receiving aircraft flying around a transmitter coil mounted to a platform on top of a tower in accordance with a further embodiment.

FIG. 14 is a block diagram identifying some components of a wireless power transfer system in which a receiving aircraft flies around a transmitter coil that is attached to a platform that is rotatably mounted to a tower in accordance with an alternative embodiment.

Reference will hereinafter be made to the drawings in which similar elements in different drawings bear the same reference numerals.

### DETAILED DESCRIPTION

For the purpose of illustration, systems and methods for recharging a battery onboard an aircraft via resonant inductive coupling will now be described in detail. However, not all features of an actual implementation are described in this specification. A person skilled in the art will appreciate that in the development of any such embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Resonant inductive coupling is the near-field wireless transmission of electrical energy between two coils that are tuned to resonate at the same frequency. Resonant transfer works by making a primary coil (referred to above and below as the “transmit coil”) ring with an oscillating current, which generates an oscillating magnetic field. A secondary coil (referred to above and below as the “receive coil”) in proximity to the primary coil can pick up energy from the oscillating magnetic field. If the primary and secondary coils are resonant at a common frequency, significant power can be transmitted at reasonable efficiency from the primary coil to the secondary coil over a range of, about one quarter wavelength, where wavelength is the speed of light divided by the frequency of the oscillating current. Resonant inductive coupling requires both a resonant frequency match and an orientation match between the transmitter and receiver (i.e., the transmitting and receiving LC circuits) for significant power transmission to occur. Specifically, the transmit coil and the receive coil are preferably oriented so that the magnetic dipole field passing through the receive coil from the transmit coil is oriented within about 45 degrees of parallel to the receive coil.

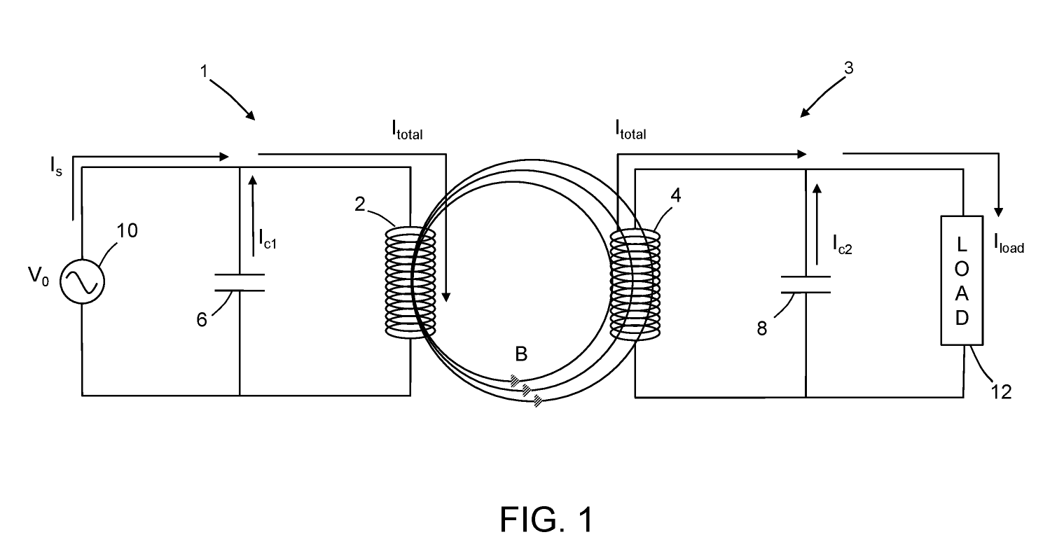

FIG. 1 is a circuit diagram representing a transmitter 1 and a receiver 3 that form a resonant system when separated by a distance within a resonant inductive coupling range. The transmitter 1 comprises an LC circuit connected to an AC source 10 (hereinafter “AC source 10”). The AC source 10 outputs an alternating current having a voltage V₀. The LC circuit in the transmitter 1 comprises a transmit coil 2 and a capacitor 6 that tunes the transmit coil 2 to produce a magnetic field B (indicated by the circles in FIG. 1) that oscillates at the resonant frequency. The transmit coil 2 receives a current Iₜₒₜₐₗ which is the sum of the current Iₛ from the AC source 10 and the current I_{c1} from the capacitor 6 (i.e., Iₛ+I_{c1}=Iₜₒₜₐₗ). The receiver 3 comprises an LC circuit connected to a load 12 (e.g., a battery charger). The LC circuit in the receiver 3 comprises a receive coil 4 and a capacitor 8 that tunes the receive coil 4 to the resonant frequency. During resonant inductive coupling, the load 12 receives a current I_{load} which is the sum of the current Iₜₒₜₐₗ induced in the receive coil 4 and the current I_{c2} from the capacitor 6 (i.e., Iₜₒₜₐₗ+I_{c2}=I_{load}).

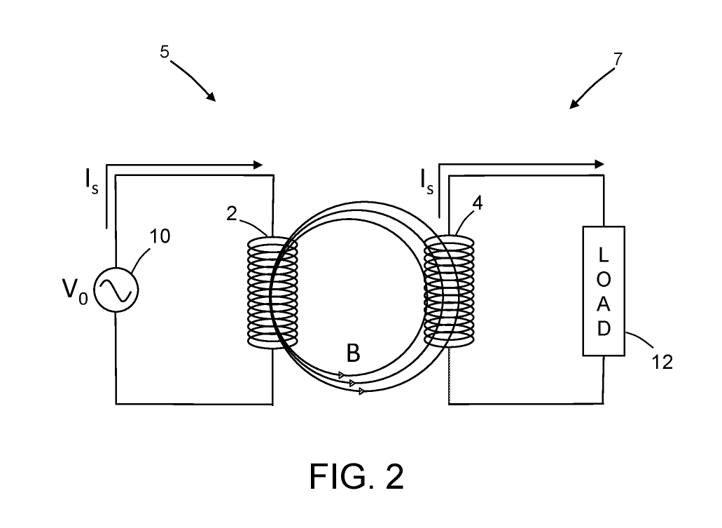

In contrast, FIG. 2 is a circuit diagram representing a transmitter 5 and a receiver 7 that form a non-resonant system when separated by a distance within an inductive coupling range. The transmitter 3 comprises an AC source 10 and a transmit coil 2 that produces a magnetic field B that oscillates at a non-resonant frequency. The transmit coil 2 receives the current Iₛ from the AC source 10. The receiver 7 comprises a receive coil 4 and a load 12. During non-resonant inductive coupling, the load 12 receives the current Iₛ induced in the receive coil 4.

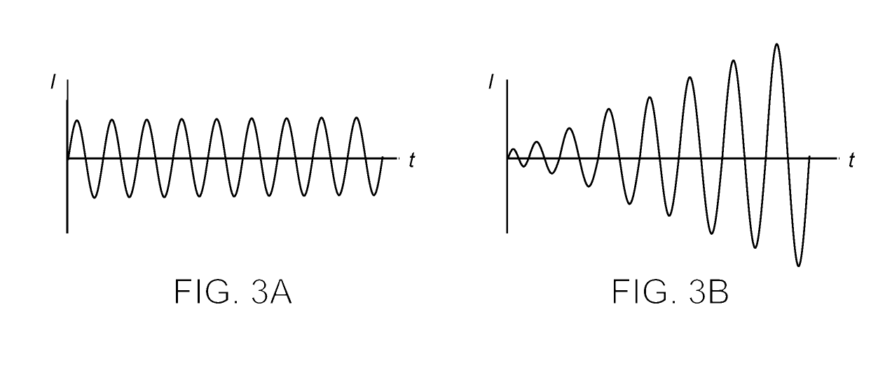

When the transmitter 1 and receiver 3 are tuned to the same resonant frequency as depicted in FIG. 1, power transfer is significantly greater than when operating at dissimilar or non-resonant frequencies (as depicted in FIG. 2). This is due to both the voltage and current being larger in the resonant system, resulting in more power produced (P=IV). FIG. 3A shows current over time in a non-resonant system, while FIG. 3B shows current over time in a resonant system. These graphs will be used to explain why power is greater in a resonant system.

The non-resonant system shown in FIG. 2 does not include a capacitor to accumulate the alternating current provided by the AC source 10. The resonant system shown in FIG. 1, however, produces a current that increases with time up to an asymptotic limit not shown in FIG. 3B. This is because current provided by the AC source 10 to the transmit coil 2 also charges the capacitor 6. When the capacitor 6 discharges, its current I_{c1} is added to the source current Iₛ and the total current Iₜₒₜₐₗ passes through the transmit coil 2. The total current Iₜₒₜₐₗ, which is larger than the source current Iₛ, charges the capacitor 6 with opposite polarity from its initial charge. When the capacitor 6 discharges, its current I_{c1} is again added to the total current Iₜₒₜₐₗ. This process is repeated continuously, creating an overall larger current in the resonant system as shown in FIG. 3B. Since magnetic flux is proportional to current, the transmit coil 2 in the resonant system produces greater flux than the transmit coil in the non-resonant system, inducing greater voltage in the receive coil 4. Because V=IR, a greater voltage also means a greater current in the receive coil 4. Similar to the situation on the transmitting side, the capacitor 8 in the receiver 3 works to deliver an asymptotically increasing current I_{c2} to the load 12.

When the transmitting coil 2 and receive coil 4 are resonantly inductively coupled, their magnetic fields are locked 90 degrees out of phase. Since voltage is directly proportional to the rate of change in magnetic flux, the current induced in the receiver coil 4 is in phase with the voltage induced by the changing flux from the transmit coil 2. Power transfer in a resonant system is thus larger than power transfer in a non-resonant system for the same AC source. Unlike non-resonant inductive transfer (e.g., transformers), the distance between the transmitting and receive coils can be as far apart as one fourth of the wavelength of the oscillating magnetic field.

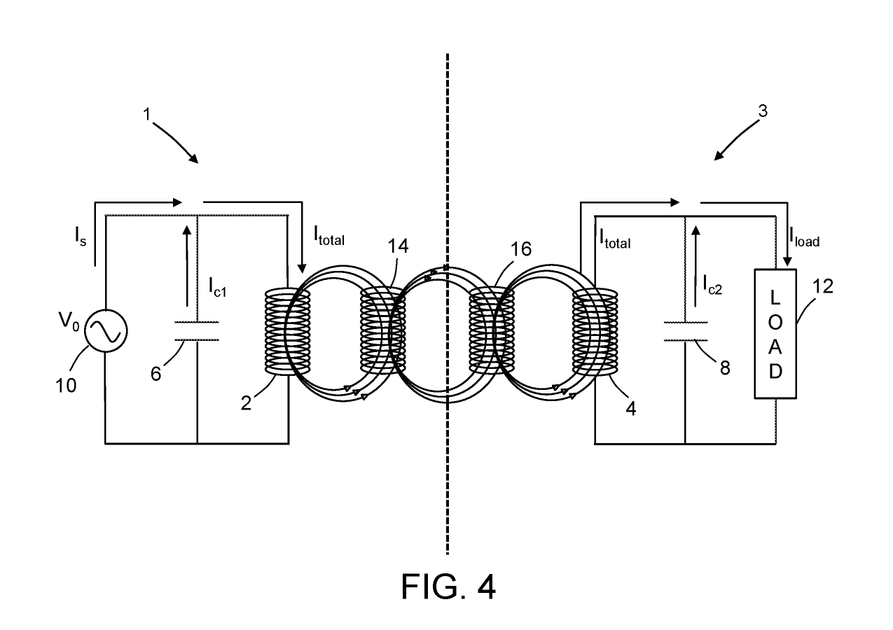

In accordance with some of the embodiments disclosed herein, “relay” coils may be used with the receiving and transmit coils to amplify the amount of power transferred. FIG. 4 is a circuit diagram representing a transmitter 1 and a receiver 3 in a resonant system with relay coils 14 and 16. The relay coil 14 is resonantly inductively coupled to the transmit coil 2; the relay coil 16 is resonantly inductively coupled to the relay coil 14; and the relay coil 16 is resonantly inductively coupled to the receive coil 4. Although not shown in FIG. 4 (for the sake of simplicity), each of the relay coils 14 and 16 is connected to a respective capacitor (not shown) to form respective LC circuits. The relay coil 14 is preferably disposed parallel and proximal to the transmit coil 2, while the relay coil 16 is preferably disposed parallel and proximal to the receive coil 4. (As used herein, the term “parallel” in the context of coils means that the axes of the coils are mutually parallel.)

As explained previously with reference to FIGS. 1-3, the addition of relay coils contributes to greater buildup of current in the circuits. Specifically, the alternating current that is driven by voltage V₀ of the AC source 10 passes through the transmit coil 2 and feeds the capacitor 6. When the capacitor 6 discharges, its current I_{c1} is added to the source current Iₛ. This process is repeated continuously, building up the total current Iₜₒₜₐₗ. The large current induces a similarly large current in the relay coil 14, which is also connected to a capacitor (not shown in FIG. 4). The current passing through the relay coil 14 charges its associated capacitor. When this capacitor discharges, its current adds to the current being induced in the relay coil 14. The current going through the relay coil 14 is now equal to the sum of Iₜₒₜₐₗ plus the extra current from the capacitor to which the relay coil 14 is electrically coupled. This total current induces current in the capacitor that is connected to the relay coil 16 on the receiver side. Through a similar process as previously described, the current going through the relay coil 16 on the receiver side is magnified by additional capacitor current from the capacitor (not shown in FIG. 4) to which relay coil 16 is electrically coupled. Finally, this current induces current on the receive coil 4 which also is magnified over time by the capacitor 8. Through the process described, the current induced in receive coil 4 is much greater than when relay coils 14 and 16 are not used and thus total power transferred is also greater (P=IV).

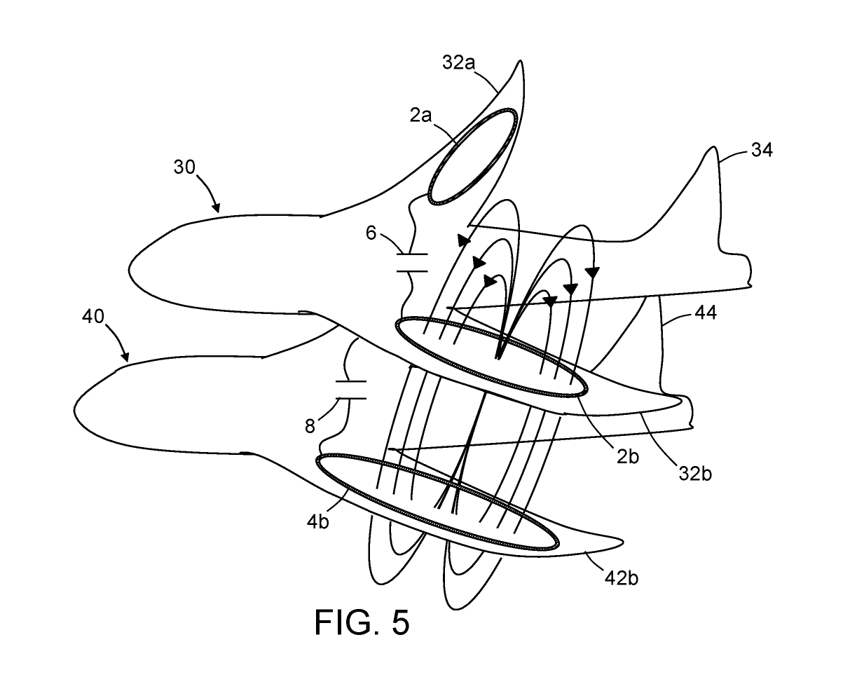

FIG. 5 is a diagram representing a view of a transmitting aircraft 30 and a receiving aircraft 40 flying in formation during wireless power transfer in accordance with one embodiment of a battery charging system. The receiving aircraft 40 is an electrically propelled aircraft, potentially unmanned, receiving battery recharging power wirelessly from the transmitting aircraft 40, which may be but need not be an electrically propelled aircraft (e.g., transmitting aircraft 30 may be a fuel-consuming aircraft).

Still referring to FIG. 5, the transmitting aircraft 30 comprises a first wing 32a, a second wing 32b and a tail 34. The transmitting aircraft 30 further comprises a first transmit coil 2a incorporated in the first wing 32a and a second transmit coil 2b incorporated in the second wing 32b. Each of the first and second transmit coils 2a and 2b is depicted in FIG. 5 as being connected to a capacitor 6 to form an LC circuit, but they may instead be respectively connected to different capacitors which tune the transmit coils to the resonant frequency. An alternating source 10 (as shown in FIG. 1) is used to drive this LC circuit. The LC circuit on the transmitting aircraft 30 operates at the same resonant frequency as the LC circuit (described below) on the receiving aircraft 40.

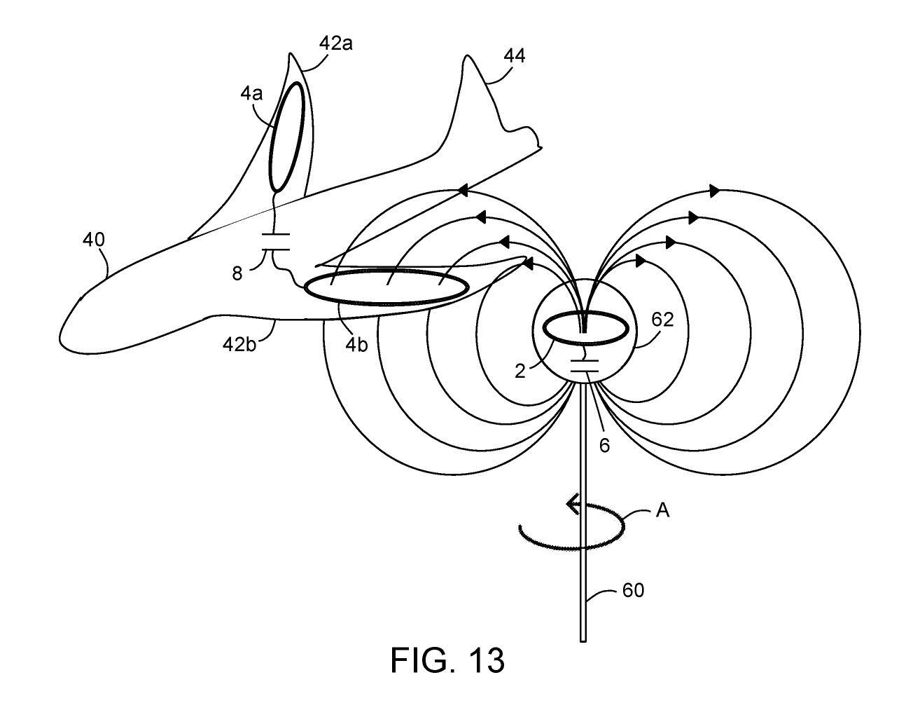

The receiving aircraft 40 comprises a first wing 42a (not visible in FIG. 5, but see FIG. 13), a second wing 42b and a tail 44. The receiving aircraft 40 further comprises a first receive coil 4a (not visible in FIG. 5, but see FIG. 13) incorporated in the first wing 42a and a second receive coil 4b incorporated in the second wing 42b. Each of the first and second receive coils 4a and 4b is depicted in FIG. 5 as being connected to a capacitor 8 to form an LC circuit, but they may instead be respectively connected to different capacitors which tune the receive coils to the resonant frequency.

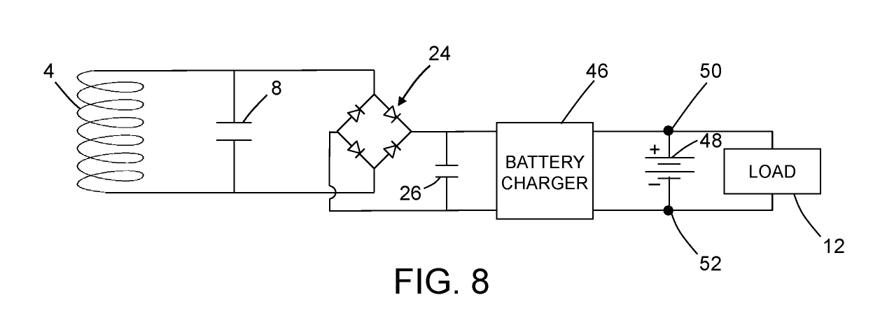

As depicted in FIG. 5, the transmitting aircraft 30 and receiving aircraft 40 are flying sufficiently close to each other that the transmit coil 2b and the receive coil 4b are separated by a distance within a resonant inductive coupling range. The oscillating magnetic field produced by the transmit coil 2b is indicated in FIG. 5 by elliptical lines with arrowheads. The resulting magnetic flux through the receive coil 4b induces current in the receive coil 4b which is then used to charge a battery (not shown in FIG. 5, but see FIG. 8) onboard the receiving aircraft 40. In a similar manner, the other transmit coil 2a produces an oscillating magnetic field that induces current in the receive coil 4a, which current is also used to recharge the battery.

To avoid large power losses due to eddy currents, the wings of both aircraft are preferably made of substantially non-conductive skin panels and structures or they use conductive elements like metal spars or carbon fibers that are insulated from each other so they do not form a closed loop. For example, embodiments preferably avoid aluminum skin panels because each provides a closed conductive loop. Embodiments preferably include fabric or plastic skin panels because they are nonconductive. Embodiments may preferably include carbon fiber-reinforced plastic (CFRP) wherein the conductive carbon fibers are not connected to each other laterally within a ply or vertically between plies.

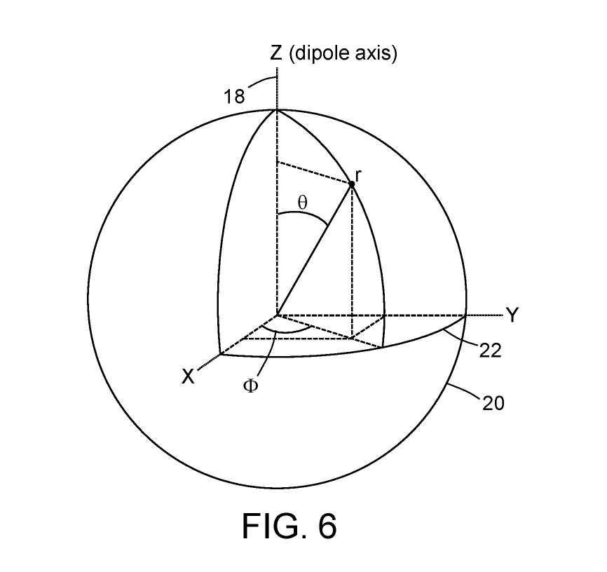

The transmitting aircraft 30 can fly above or below the receiving aircraft 40, preferably such that the wings of the receiving and transmitting aircraft are parallel and lined up, thereby producing the maximum amount of flux passing through the receive coils 4a and 4b. FIG. 6 is a diagram representing a unit sphere model 20 of a magnetic dipole having a dipole axis 18. Ideally, the wings of the receiving and transmitting aircraft are lined up on top of each other because for a given separation distance r, the magnetic field near the poles of the dipole is twice as strong as the magnetic field near the dipole's equator 22. The equator is defined as when θ equals 90 degrees. The poles are defined as when θ is equal to either 0 or 180 degrees.

Although FIG. 5 depicts the transmitting aircraft 30 flying directly above the receiving aircraft 40 with the wings 32a and 32b of the transmitting aircraft 30 respectively overlying the wings 42a and 42b of the receiving aircraft 40, in an alternative scenario the transmitting aircraft 30 and receiving aircraft 40 could be laterally offset such that the wing 32a of the transmitting aircraft 30 overlies the wing 42b of the receiving aircraft 40, so that power is transferred wirelessly only from the transmit coil 2a to the receive coil 4b. Thus it is not necessary that two transmit coils be resonantly inductively coupled to two receive coils in order to transfer power. Resonant inductive coupling of a single transmit coil to a single receive coil is sufficient to produce some current for recharging the battery onboard the receiving aircraft.

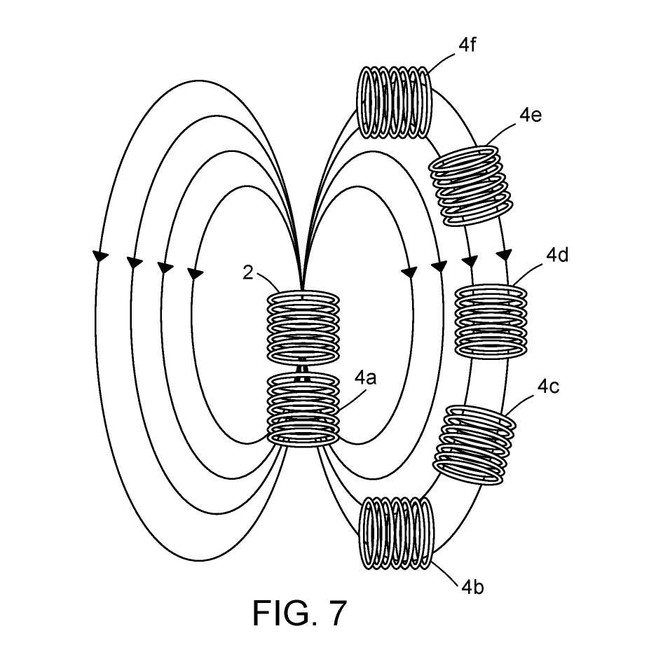

Ideally, the transmit and receive coils should be oriented such that the greatest amount of flux passes from the transmit coil to the receive coil. The more flux that passes through the receive coil, the greater the amount of induced current and thus the greater the amount of power transferred. This occurs when the two coils are oriented so that the receive coil has its cross section perpendicular to the incoming flux. FIG. 7 is a horizontally compressed representation (the magnetic field lines from a dipole extend farther around the equator than at the poles) of a transmit coil 2 and various receive coils 4a-4f having respective orientations for maximum flux capture during resonant inductive coupling due to the fact that the axis of the receive coil is perpendicular to the magnetic flux lines.

Preferably the LC circuits onboard the receiving and transmitting aircraft have a high Q factor value (which is influenced by the conductivity, shape, and thickness of the conductor) to enable greater efficiency in current induction and thus a greater magnitude of power transferred.

FIG. 8 is a circuit diagram identifying some components of a battery charging system onboard a receiving aircraft 40 in accordance with one embodiment. The receiving aircraft 40 comprises: a receive coil 4 in which an alternating current is induced; a capacitor 8 that is connected to the receive coil 4 for tuning the receive coil 4 to a resonant frequency; a rectifier 24 that is connected to the receive coil 4 and to the capacitor 8 for converting alternating current from the receive coil 4 and capacitor 8 into direct current; a smoothing capacitor 26 that is connected to receive direct current from the rectifier 24; a battery charger 46 that is connected to receive direct current from the rectifier 24 and to the smoothing capacitor 26; and a battery 48 having a positive terminal 50 and a negative terminal 52 connected to the battery charger 46. The battery charger 46 is configured to charge the battery 48 using direct current produced from alternating current induced in the receive coil 4 and alternating current produced by the capacitor 8. More specifically, the battery charger 46 may comprise a voltage regulator to avoid overcharging the battery 48, a current limiter to ensure that charging does not occur too rapidly, and temperature sensors which indicate to the battery charger 46 when charging should cease because the battery 48 is overheating. As depicted in FIG. 8, once the battery 48 has been recharged, it can be used to provide direct current to a load 12.

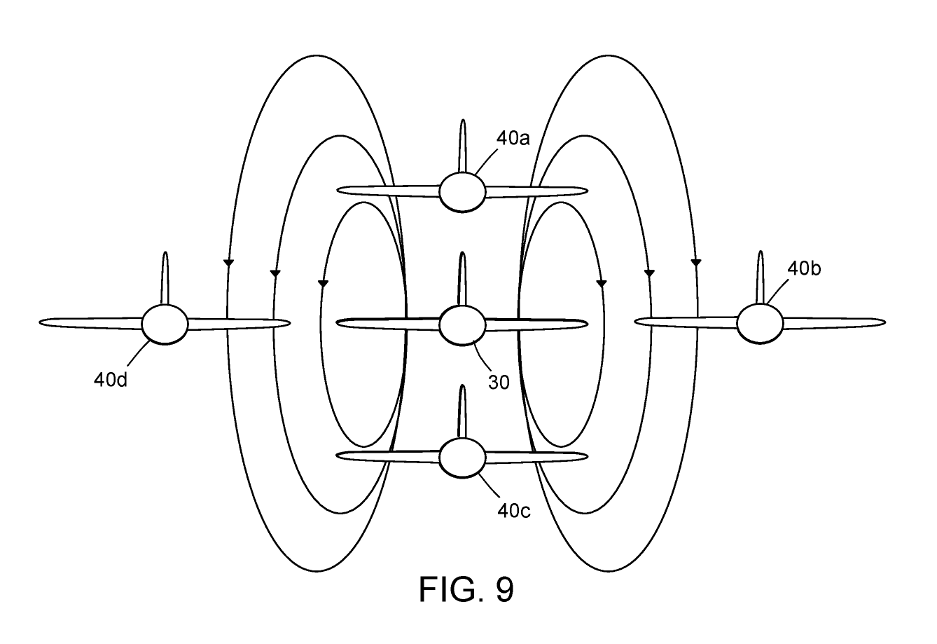

FIG. 9 is a diagram representing a front view of a transmitting aircraft 30 and a multiplicity of receiving aircraft 40a-40d flying in formation (in the direction out of the page) during wireless power transfer in accordance with another embodiment. Each aircraft depicted in FIG. 9 is equipped with coils in both wings. More specifically, each receiving aircraft 40a-40d incorporates the battery charging system depicted in FIG. 8.

Receiving aircraft 40a is flying above the transmitting aircraft 30; receiving aircraft 40b is flying on the port side of the transmitting aircraft 30; receiving aircraft 40c is flying below the transmitting aircraft 30; and receiving aircraft 40d is flying on the starboard side of the transmitting aircraft 30. In the scenario depicted in FIG. 9, one receive coil incorporated in the starboard wing of the receiving aircraft 40a is resonantly inductively coupled to one transmit coil incorporated in the starboard wing 32a of transmitting aircraft 30, while another receive coil incorporated in the port wing of the receiving aircraft 40a is resonantly inductively coupled to another transmit coil incorporated in the port wing 32b of transmitting aircraft 30. The same is true for the receiving aircraft 40c flying below the transmitting aircraft 30. In addition, one receive coil incorporated in the starboard wing of the receiving aircraft 40b is resonantly inductively coupled to the transmit coil incorporated in the port wing 32b of transmitting aircraft 30, while one receive coil incorporated in the port wing of the receiving aircraft 40d is resonantly inductively coupled to the transmit coil incorporated in the starboard wing 32a of transmitting aircraft 30. In accordance with this flight formation, the transmitting aircraft 30 can transfer power wirelessly to four receiving aircraft concurrently.

It should be pointed out that the elliptical lines with arrowheads depicted in FIG. 9 represent only one-half of the oscillating magnetic field produced by each transmit coil incorporated in the wings of the transmitting aircraft. For example, the not depicted portion of the magnetic field produced by the transmit coil in port wing 32b of the transmitting aircraft may transfer some power to the receive coils in the starboard wings of receiving aircraft 40a and 40c, as well as transferring more power to the receive coils in the port wings of receiving aircraft 40a and 40c. Similarly, the not depicted portion of the magnetic field produced by the transmit coil in starboard wing 32a of the transmitting aircraft may transfer some power to the receive coils in the port wings of receiving aircraft 40a and 40c, as well as transferring more power to the receive coils in the starboard wings of receiving aircraft 40a and 40c.

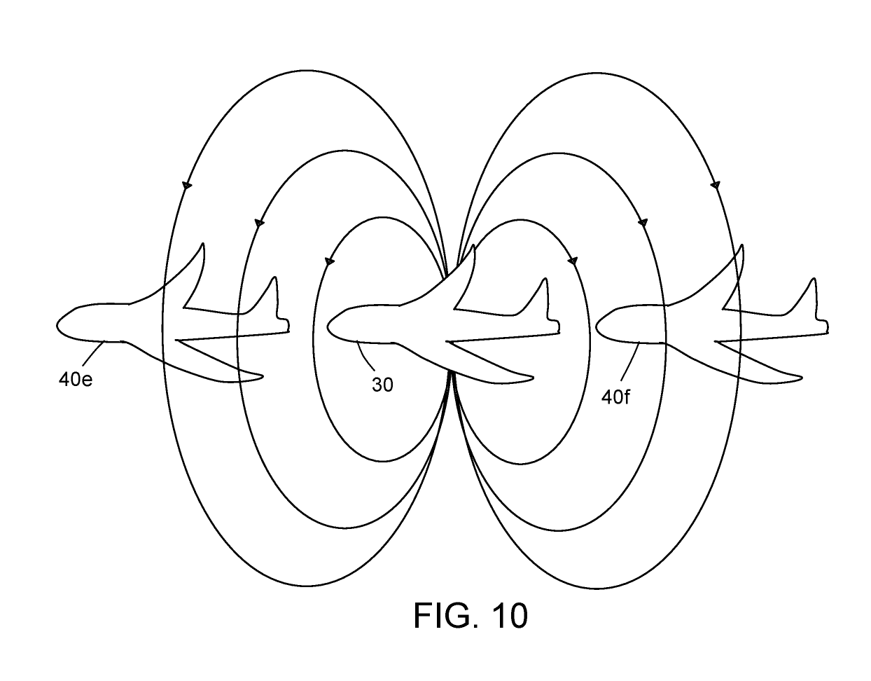

FIG. 10 is a diagram representing a side view of a transmitting aircraft 30, a leading receiving aircraft 40e and a trailing receiving aircraft 40f flying in formation during wireless power transfer in accordance with a further embodiment. Each aircraft depicted in FIG. 10 is equipped with coils in both wings. More specifically, each of the receiving aircraft 40e and 40f incorporates the battery charging system depicted in FIG. 8.

In the scenario depicted in FIG. 10, the receiving aircraft 40e is flying forward of the transmitting aircraft 30, while receiving aircraft 40f is flying aft of the transmitting aircraft 30. In the scenario depicted in FIG. 10, the receive coils incorporated in the wings of the receiving aircraft 40e and 40f are resonantly inductively coupled to one or both of the transmit coils incorporated in the wings of the transmitting aircraft 30. In accordance with this flight formation, the transmitting aircraft 30 can transfer power wirelessly to two receiving aircraft concurrently.

In accordance with a further alternative embodiment, the transmitting aircraft could fly in formation with the four receiving aircraft 40a-40d depicted in FIG. 9 and the two receiving aircraft 40e and 40f depicted in FIG. 10, in which case six receiving aircraft could receive power for battery recharging concurrently.

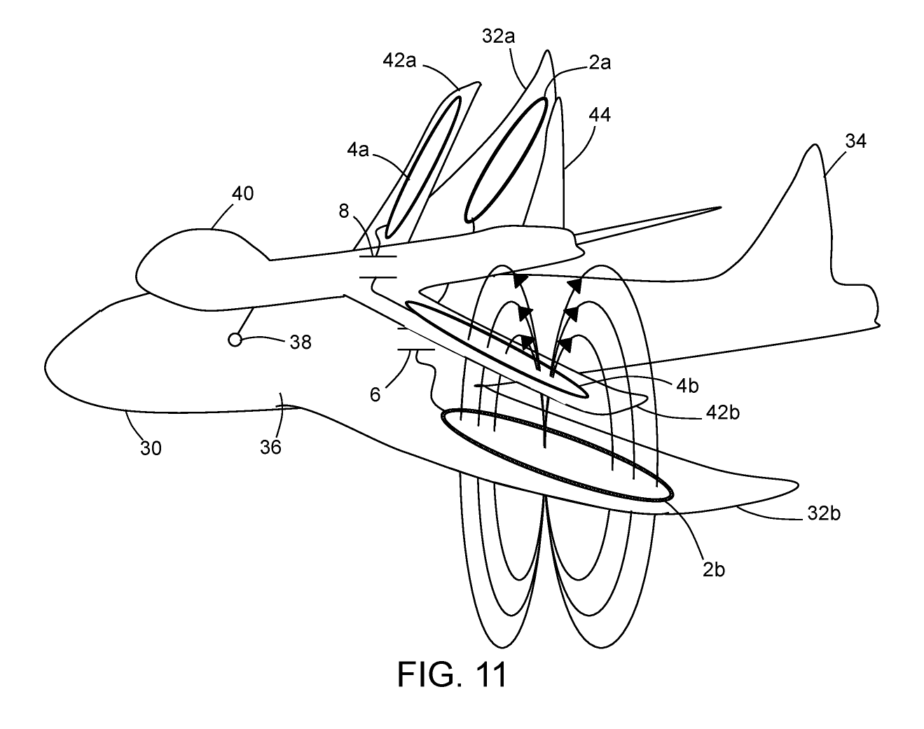

FIG. 11 is a diagram representing a view of a scenario in which a receiving aircraft 40 receives power via resonant inductive coupling after bringing its wheels into contact with a transmitting aircraft 30 that continues to fly. In this case the receiving aircraft 40 is smaller and lighter in weight than the transmitting aircraft 40. The receiver aircraft 40 lands on top of the fuselage 36 (or a landing platform built on top of the fuselage) of the transmitting aircraft 30. The wheels 38 (only one of which is visible in FIG. 11) of the receiving aircraft 30 are placed on the transmitting aircraft 30 so that the former is now supported by the latter as the latter continues to fly, at which time the engines of the receiving aircraft can be operated in an idle mode or turned off. Means (e.g., stops on the surface of the fuselage 36 of the transmitting aircraft 30) may be provided for preventing rearward movement of the receiving aircraft 40 relative to the transmitting aircraft 30 while the former is parked on the latter during battery recharging.

The receiving aircraft 40 incorporates the battery charging system depicted in FIG. 8. As indicated by the elliptical lines with arrowheads in FIG. 11, the receive coil 4b incorporated in the port wing 42b of the receiving aircraft 40 is resonantly inductively coupled to the transmit coil 2b incorporated in the port wing 32b of transmitting aircraft 30. Although not indicated by similar elliptical lines, the receive coil 4a incorporated in the starboard wing 42a of the receiving aircraft 40 is likewise resonantly inductively coupled to the transmit coil 2a incorporated in the starboard wing 32a of transmitting aircraft 30. In this manner, power can be transferred wirelessly from the transmitting aircraft 30 to the receiving aircraft 40 for recharging one or more batteries onboard the receiving aircraft 40.

In accordance with an alternative embodiment, the transmitting aircraft 30 is smaller and lighter in weight than the receiving aircraft 40, in which case the transmitting aircraft 30 would land on the receiving aircraft 40, not vice versa.

In either case, ideally the wings, and thus the coils, of one aircraft should be directly above and parallel to the other, such that the receive coil is perpendicular to the flux generated by the transmit coil. Contact between the two aircrafts via the wheels assures that no dents or scratches are made on the upper surface of the aircraft being landed on, in addition to bringing the coils as close together as possible.

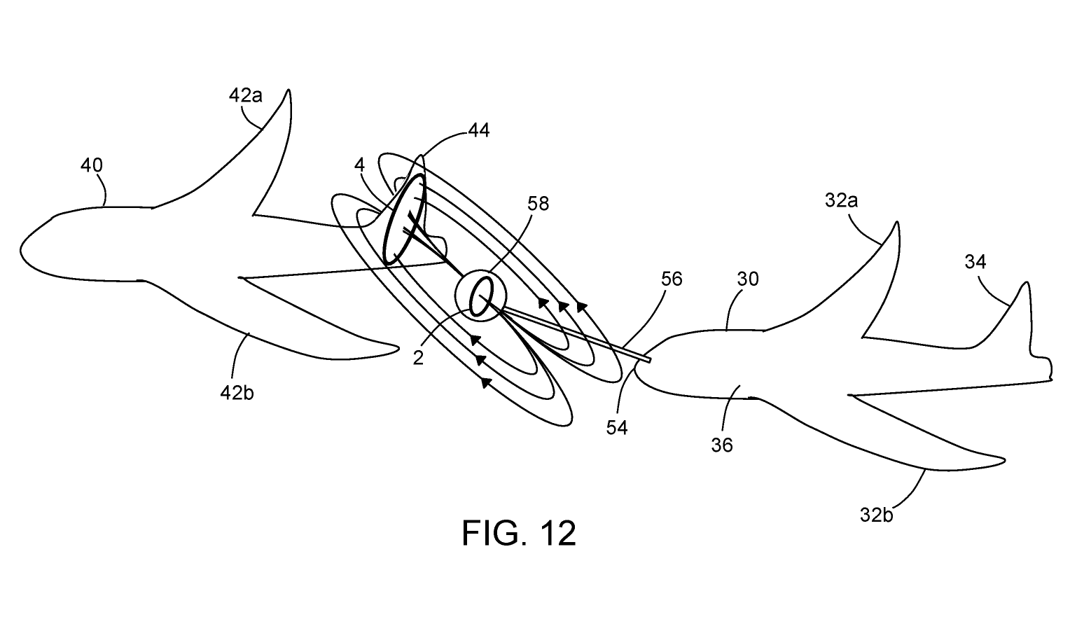

FIG. 12 is a diagram representing a view of a leading receiving aircraft 40 and a trailing transmitting aircraft 30 flying in formation during wireless power transfer in accordance with an alternative embodiment in which the transmit coil 2 is located forward of the nose 54 of the transmitting aircraft 30 and the receive coil 4 is located in the tail 44 of the receiving aircraft 40. More specifically, the transmitting aircraft 30 comprising a nose 54, a pole 56 extending forward from the nose 54, coil support disk 58 attached to a distal end of the pole 56, a transmit coil 2 attached to and supported by the coil support disk 58, a capacitor (not shown in FIG. 12, but see capacitor 6 in FIG. 1) connected to the transmit coil 2 for tuning the transmit coil 2 to the resonant frequency, and an alternating current source (not shown in FIG. 12, but see AC source 10 in FIG. 1) connected to the transmit coil 2 and the capacitor. The receiving aircraft 40 incorporates the battery charging system depicted in FIG. 8.

Still referring to FIG. 12, the transmitting aircraft 30 flies in formation with the receiving aircraft 40 so that the magnetic flux from the transmit coil 2 is perpendicular to the plane of the receive coil 4. Ideally, the transmitting and receiving aircraft should be positioned so that the maximum amount of flux from the transmit coil 2 passes through the receive coil 4 while maintaining safe separation between aircraft 30 and aircraft 40.

In accordance with the embodiment depicted in FIG. 12, the wings, tail and fuselage of each aircraft do not need to be physically close to each other, thereby reducing the likelihood or consequences of potential collisions. Wireless power transmission will occur as long as the transmit coil 2 is separated from the receive coil 4 by a distance that is with the resonant inductive coupling range.

FIG. 13 is a diagram representing a view of a receiving aircraft 40 flying around a transmitter coil 2 mounted to a platform 62 on top of a tower 60 in accordance with a further embodiment. The receiving aircraft 40 incorporates the battery charging system depicted in FIG. 8.

The tower 40 extends from the ground into an airspace. The tower 40 may be in the form of a pole. The platform 62 is mounted to the top of the tower 40. The transmit coil 2 is attached to the platform 62. A capacitor (not shown) is connected to the transmit coil 2 for tuning the transmit coil 2 to the resonant frequency. An alternating current source (not shown) is connected to the transmit coil 2 and the capacitor. The tower 60 is preferably installed in an area where the ground has low electrical conductivity, such as a desert or airport tarmac. Low conductivity minimizes loss of power to eddy currents.

The receiving aircraft 40 may be either an electrically propelled or a fuel-consuming aircraft. One or both wings of the receiving aircraft 40 may incorporate a receive coil 4 to which a capacitor is connected to form an LC circuit. The capacitor tunes the receive coil to the resonant frequency. The LC circuit on the platform 62 operates at the same resonant frequency as the LC circuit onboard the receiving aircraft 40.

In order to effect wireless power transmission sufficient to charge the battery onboard the receiving aircraft 40, the receiving aircraft 40 flies around the tower 60 such that magnetic flux from the transmit coil 2 passes through the receive coil 4, i.e., the receive coil 4 and the transmit coil 2 are separated by a distance within a resonant inductive coupling range. Ideally, the receiving aircraft 40 should be positioned so that the maximum amount of magnetic flux produced by the transmit coil 2 passes through the receive coil 4, i.e., the receiving aircraft 40 flies at an altitude and a bank angle that keeps the receive coil 4 roughly perpendicular to the magnetic flux produced by the transmit coil 2. Receive coils 4 may be located in either wing for flexibility when choosing which wing to fly closest to the tower 60. This configuration is illustrated in FIG. 13. Alternatively, the receive coil 4 may be located in only one wing to minimize weight.

Optionally, the platform 62 may be rotatable. The platform 62 may be rotatable about the axis of the tower 60 (i.e., a pan axis). The platform 62 may also be rotatable about a tilt axis. A rotatable platform may be useful in cases where the axis of transmit coil 2 is not vertical which, together with rotation of platform 62, may cause magnetic flux to be more nearly perpendicular to receive coil 4b.

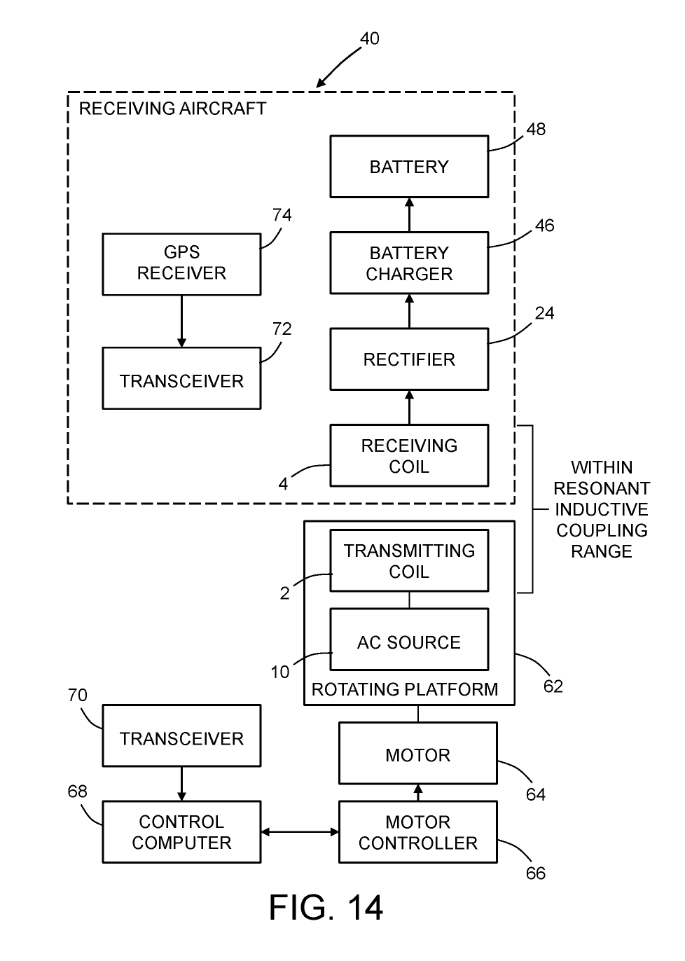

FIG. 14 is a block diagram identifying some components of a wireless power transfer system in which a receiving aircraft 40 flies around a transmitter coil 2 that is attached to a rotatable platform 62 in accordance with the aforementioned alternative embodiment. motor 64. The receiving aircraft 40 is equipped with a global positioning system receiver 74 (hereinafter “GPS receiver 74”) which receives GPS signals for continuously determining the global coordinate position of the receiving aircraft 40 as it circumnavigates the tower 60. Position signals representing the position coordinates of the receiving aircraft 40 are broadcast by a transceiver 70 that is onboard the receiving aircraft 40. Those position signals are received by a transceiver 72 on the ground, which in turn sends the position information to a control computer 68, also located on the ground. The control computer 68 is configured to control the angular position of the transmit coil 2 as a function of the position of the circumnavigating receiving aircraft 40, essentially tracking the receiving aircraft 40 for the purpose of optimizing amount of power transferred from the transmit coil 2 to the receive coil 4. This is accomplished by the control computer issuing control signals to a motor controller 66, which motor controller 66 controls the operation of a motor 64. The motor 64 is mechanically coupled to the rotating platform 62, causing the rotating platform 62 to rotate in accordance with the information contained in the control signals issued by the control computer 68. More specifically, the control computer 68 may be programmed to continuously control the angular position of the transmit coil 2 to optimize the amount of power being transferred from the transmit coil 2 to the receive coil 4 as a function of the changing coordinate position of the circumnavigating receiving aircraft 40.

In cases where the receiving aircraft is electrically propelled, the wireless battery charging methodologies disclosed herein extend the range and duration of flight for receiving aircraft (e.g., unmanned aerial vehicles). In addition, the technology disclosed herein reduces the battery size needed to power the electrically propelled aircraft, thereby reducing cost and increasing flight duration and efficiency as a result of reduced weight. Furthermore, this technology enables long-distance missions that are otherwise difficult for electrically propelled aircraft without a form of aerial recharging. In addition, resonant inductive coupling can be used to charge an aircraft on the ground. Instead of using manpower and cables to recharge an aircraft, the aircraft may be placed next to a resonant power transmitter while parked on the ground.

While systems and methods for recharging a battery onboard an aircraft using resonant inductive coupling of coils have been described with reference to various embodiments, it will be understood by those skilled in the art that various changes may be made and equivalents may be substituted for elements thereof without departing from the scope of the teachings herein. In addition, many modifications may be made to adapt the teachings herein to a particular situation without departing from the scope thereof. Therefore it is intended that the claims not be limited to the particular embodiments disclosed herein.

The method claims set forth hereinafter should not be construed to require that the steps recited therein be performed in alphabetical order (any alphabetical ordering in the claims is used solely for the purpose of referencing previously recited steps) or in the order in which they are recited unless the claim language explicitly specifies or states conditions indicating a particular order in which some or all of those steps are performed. Nor should the process claims be construed to exclude any portions of two or more steps being performed concurrently or alternatingly unless the claim language explicitly states a condition that precludes such an interpretation.

1. A method for recharging a battery onboard a receiving aircraft, comprising:
positioning the receiving aircraft so that a receive coil onboard the receiving aircraft is within a resonant inductive coupling range of a transmit coil not onboard the receiving aircraft;
transferring power wirelessly from the transmit coil to the receive coil onboard the receiving aircraft by supplying an alternating current to the transmit coil while the receive coil is within the resonant inductive coupling range;
converting electric current induced in the receive coil to direct current; and
charging the battery using at least some of the direct current.

2. The method as recited in claim 1, wherein the receiving aircraft and the transmit coil are on the ground during wireless power transfer.

3. The method as recited in claim 1, wherein the transmit coil is mounted to a tower that extends from ground into an airspace and the receiving aircraft is in flight during wireless power transfer.

4. The method as recited in claim 3, wherein the transmit coil is rotatably mounted to the tower, the method further comprising the following steps performed during wireless power transfer:
flying the receiving aircraft along a path that circumnavigates the tower at distances within the resonant inductive coupling range; and
rotating the transmit coil during circumnavigation by the receiving aircraft.

5. The method as recited in claim 1, further comprising:
broadcasting position signals from the receiving aircraft representing a current position of the receiving aircraft; and
controlling an angular position of the transmit coil in accordance with the broadcast position signals.

6. The method as recited in claim 1, wherein the transmit coil is onboard a transmitting aircraft.

7. The method as recited in claim 6, further comprising:
flying the receiving aircraft along a first flight trajectory; and
flying the transmitting aircraft along a second flight trajectory that maintains the transmit coil within the resonant inductive coupling range of the receive coil,
wherein wireless power transfer occurs while the receiving and transmitting aircraft are concurrently flying along the first and second flight trajectories respectively.

8. The method as recited in claim 7, wherein the transmit coil is incorporated in a wing of the transmitting aircraft.

9. The method as recited in claim 7, wherein the receive coil is incorporated in a wing of the receiving aircraft.

10. The method as recited in claim 6, further comprising:
flying the transmitting aircraft in a vicinity of the receiving aircraft; and
landing the receiving aircraft on the transmitting aircraft,
wherein wireless power transfer occurs while the receiving aircraft is in contact with the transmitting aircraft.

11. A battery recharging system comprising a receiving aircraft comprising first and second wings, a tail, a receive coil, a capacitor connected to the receive coil for tuning the receive coil to a resonant frequency, a rectifier connected to the receive coil and to the capacitor for converting alternating current from the receive coil and capacitor into direct current; a battery charger connected to receive direct current from the rectifier, and a battery, wherein the battery charger is configured to charge the battery using direct current produced from alternating current induced in the receive coil and alternating current produced by the capacitor.

12. The battery recharging system as recited in claim 11, further comprising a relay coil disposed within a resonant inductive coupling range of the receive coil.

13. The battery recharging system as recited in claim 11, wherein the receive coil is incorporated in one of the first and second wings.

14. The battery recharging system as recited in claim 13, further comprising a transmitting aircraft comprising first and second wings, a transmit coil incorporated in one of the first and second wings, a capacitor connected to the transmit coil for tuning the transmit coil to the resonant frequency, and an alternating current source connected to the transmit coil and the capacitor, wherein the receive coil and the transmit coil are separated by a distance within a resonant inductive coupling range.

15. The battery recharging system as recited in claim 14, further comprising a relay coil disposed within a resonant inductive coupling range of the transmit coil.

16. The battery recharging system as recited in claim 11, wherein the receive coil is incorporated in the tail.

17. The battery recharging system as recited in claim 16, further comprising: a transmitting aircraft comprising a nose, a pole extending forward from the nose, a transmit coil supported at a distal end of the pole, a capacitor connected to the transmit coil for tuning the transmit coil to the resonant frequency, and an alternating current source connected to the transmit coil and the capacitor, wherein the receive coil and the transmit coil are separated by a distance within a resonant inductive coupling range.

18. The battery recharging system as recited in claim 11, further comprising a tower extending from ground into an airspace, a platform rotatably coupled to the tower, a transmit coil mounted to the platform, a capacitor connected to the transmit coil for tuning the transmit coil to the resonant frequency, and an alternating current source connected to the transmit coil and the capacitor, wherein the receive coil and the transmit coil are separated by a distance within a resonant inductive coupling range.

19. A battery recharging system comprising:
a receiving aircraft comprising wings, a receive coil incorporated in a wing, a capacitor coupled to the receive coil for tuning the receive coil to a resonant frequency, a rectifier coupled to the receive coil and to the capacitor for converting alternating current from the receive coil and capacitor into direct current; a battery charger coupled to receive direct current from the rectifier, and a battery, wherein the battery charger is configured to charge the battery using direct current produced from alternating current induced in the receive coil and alternating current produced by the capacitor; and
a transmitting aircraft comprising wings, a transmit coil incorporated in a wing, a capacitor coupled to the transmit coil for tuning the transmit coil to the resonant frequency, and an alternating current source connected to the transmit coil and the capacitor,
wherein the first receive coil and first transmit coil are separated by a distance within a resonant inductive coupling range.

20. The battery recharging system as recited in claim 19, wherein the receiving aircraft further comprises a plurality of wheels which are in contact with the transmitting aircraft.

21. An aircraft comprising a nose, a pole extending forward from the nose, a transmit coil supported at a distal end of the pole, a capacitor connected to the transmit coil for tuning the transmit coil to a resonant frequency, and an alternating current source connected to the transmit coil and the capacitor.
